(19) United States
(12) Patent Application Publication
(10) Pub. No.: US 2010/0283913 A1
(43) Pub. Date: Nov. 11, 2010

(54) SYSTEM FOR CONTROLLING LIGHT EMISSION OF TELEVISION

(76) Inventor: Joemel Caballero, Hong Kong (HK)

Correspondence Address: BYIP, LTD., P.O. BOX 1484, GENERAL POST OFFICE, HONG KONG, HK

(21) Appl. No.: 12/436,143

(22) Filed: May 6, 2009

(51) Int. Cl. H04N 5/63; G09G 5/00

(52) U.S. Cl. 348/730; 345/207; 348/E05.127

(57) ABSTRACT

A system for controlling light emission of a LCD or an OLED TV includes an infrared light sensing assembly for detecting human presence in front of a TV within a predetermined detection angle and a power control circuit electrically connected to the infrared light sensing assembly, the TV's power supply and a backlight module (LCD TV) or an OLED assembly (OLED TV). The infrared light sensing assembly transmits a first signal to the power control circuit when human presence is detected, and transmits a second signal to the power control circuit when no human presence is detected. The power control circuit allows power to be transmitted from the power supply to the backlight module or the OLED assembly when the first signal is received and disallow power to be transmitted from the power supply to the backlight module or the OLED assembly when the second signal is received.

### FIELD OF THE PATENT APPLICATION

The present patent application generally relates to control systems for televisions and more particularly to a system for automatically controlling the light emission of a television.

### BACKGROUND

Televisions (TVs) not based on CRTs (cathode ray tubes) such as LCD (liquid crystal display) TVs and OLED (organic light-emitting diode) TVs are becoming more and more popular today. A LCD TV usually includes a backlight module for providing light emission to a user in front of the TV so as to display images. The backlight module usually includes multiple CCFLs (cold cathode fluorescent lamps) or LEDs (light-emitting diodes) as light sources. In operation, a significant portion of the electric power consumed by the LCD TV is consumed by the backlight module. In an OLED TV, an electric current flows through a light emissive organic compound in the OLED display so that light is emitted and images can be displayed. The brightness of the display is determined by the magnitude of this current. The power consumed by the OLED display, which is a significant portion of the total power consumed by the OLED TV, is directly related also to this current.

In many occasions, the user of the TV may leave the TV for a period of time while leaving the display of the TV operating as normal. When the user is away, the display of the TV is actually not used, and the power consumed by the backlight module of a LCD TV or by the current enabling light emission of an OLED display is wasted. In addition, during this period of time, in many cases, although not physically present in front of the TV and able to actually view the TV, the user may still want to hear the audio output of the TV. For example, the user may be working in a kitchen while listening to a news program played by the TV, which is located in a living room. Furthermore, when the user returns to the TV after the temporary leave, it is usually preferred that the user can continue watching the TV without making any adjustment to the TV.

### SUMMARY

The present patent application is directed to a system for controlling the light emission of a television. In one aspect, the television has a backlight module and a power supply and the system includes an infrared light sensing assembly for detecting human presence in front of the television within a predetermined detection angle, and a power control circuit electrically connected to the infrared light sensing assembly, the power supply of the television, and the backlight module of the television. The infrared light sensing assembly is configured to transmit a first signal to the power control circuit when human presence is detected, and transmit a second signal to the power control circuit when no human presence is detected. The power control circuit is configured to allow electric power to be transmitted from the power supply to the backlight module when the first signal is received and disallow electric power to be transmitted from the power supply to the backlight module when the second signal is received.

In one embodiment, the backlight module includes at least a cold cathode fluorescent lamp.

In another embodiment, the backlight module includes a plurality of light-emitting diodes.

In another aspect, the television has an organic light-emitting diode (OLED) assembly and a power supply, and the system includes an infrared light sensing assembly for detecting human presence in front of the television within a predetermined detection angle, and a power control circuit electrically connected to the infrared light sensing assembly, the power supply of the television, and the OLED assembly of the television. The infrared light sensing assembly is configured to transmit a first signal to the power control circuit when human presence is detected, and transmit a second signal to the power control circuit when no human presence is detected. The power control circuit is configured to allow electric power to be transmitted from the power supply to the OLED assembly when the first signal is received and disallow electric power to be transmitted from the power supply to the OLED assembly when the second signal is received.

### BRIEF DESCRIPTION OF THE DRAWINGS

Specific embodiments of disclosed in the present patent application will now be described by way of example with reference to the accompanying drawings wherein:

FIG. 1 is a functional block diagram of a system for controlling the light emission of a TV according to an embodiment of the present patent application;

FIG. 2A is a top view of a TV with the system illustrated in FIG. 1 and a user in front of the TV;

FIG. 2B is a side view of the TV and the user illustrated in FIG. 2A;

FIG. 3 is a schematic circuit diagram of a circuit that implements the system illustrated in FIG. 1; and

FIG. 4 is a functional block diagram of a system for controlling the light emission of a TV according to another embodiment of the present patent application.

### DETAILED DESCRIPTION

Reference will now be made in detail to embodiments of the system for controlling the light emission of a TV in the present patent application, examples of which are also provided in the following description. Exemplary embodiments of the system for controlling the light emission of a TV disclosed in the present patent application are described in detail, although it will be apparent to those skilled in the relevant art that some features that are not particularly important to an understanding of the system for controlling the light emission of a TV may not be shown for the sake of clarity.

Furthermore, it should be understood that the system for controlling the light emission of a TV disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

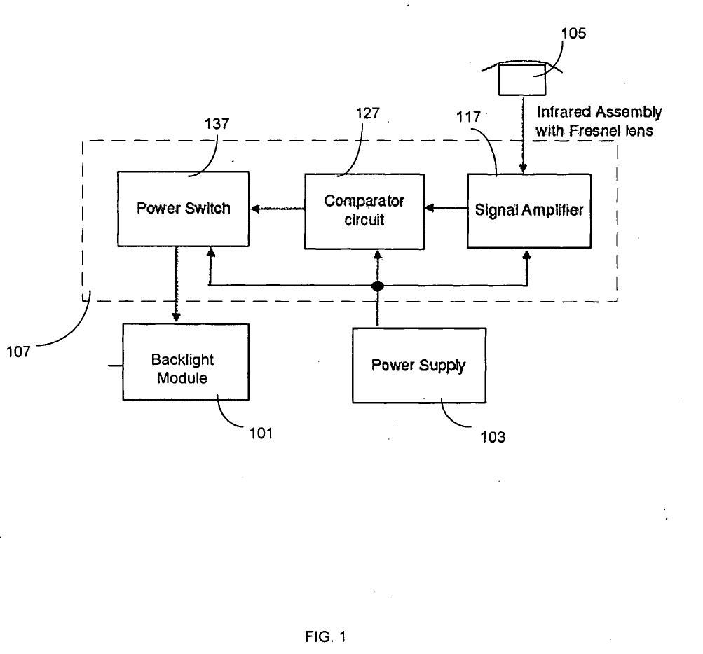

FIG. 1 is a functional block diagram of a system for controlling the light emission of a TV according to an embodiment of the present patent application. Referring to FIG. 1, the TV includes a backlight module 101 and a power supply 103. In this embodiment, the TV is a LCD TV. The system includes an infrared light sensing assembly 105, and a power control circuit 107. The power control circuit 107 is electrically connected between the power supply 103 and the backlight module 101 and configured for controlling the electric power supplied to the backlight module 101. The power control circuit 107 is also electrically connected to the infrared light sensing assembly 105 and controlled thereby.

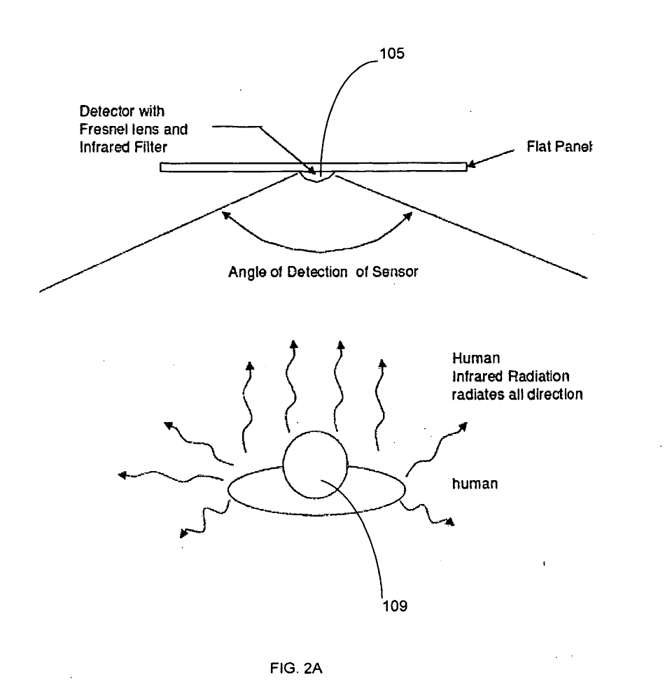

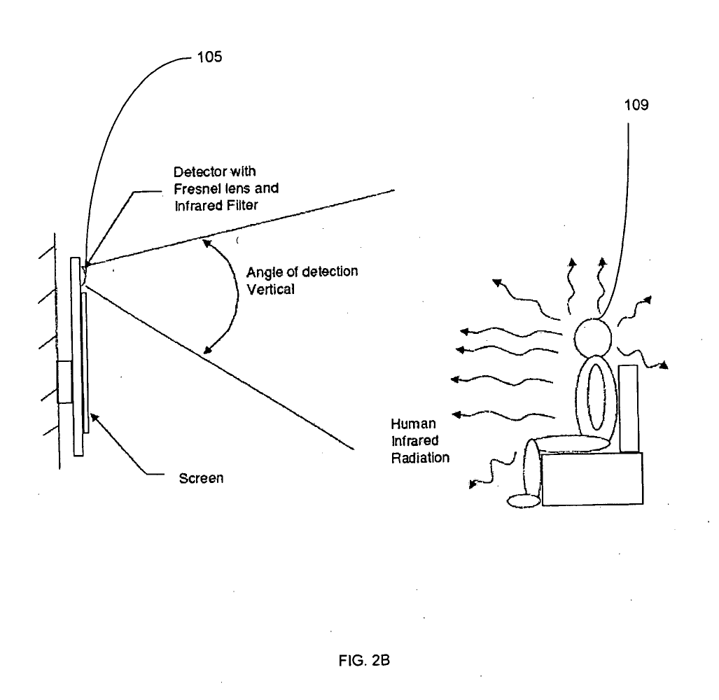

FIG. 2A is a top view of a TV with the system in this embodiment and a user in front of the TV. FIG. 2B is a side view of the TV and the user illustrated in FIG. 2A. The infrared light sensing assembly 105 includes an infrared light sensor, a Fresnel lens encapsulating the infrared light sensor and a long pass filter that is deposited on the Fresnel lens and disposed between the infrared light sensor and the Fresnel lens. Referring to FIGS. 2A and 2B, in this embodiment, the infrared light sensing module 105 is mounted to the middle of the top or bottom bezel of the TV. It is understood that the specific location of the infrared light sensing assembly 105 on the TV may depend on the specific ornamental design of the TV. When the human user 109 is present in front of the TV, the infrared light emitted by the user 109 can be detected by the infrared light sensing assemble 105. A human body with clothing normally emits infrared light in the 6 μm to 12 μm wavelength range. The long pass filter attenuates shorter wavelengths and passes longer wavelengths over the spectrum of 5 μm to 7 μm, essentially allowing only infrared light radiated by the human body to pass through. It is understood here to achieve the same optical filtering effect, the long pass filter can also be deposited on a side of the Fresnel lens that is away from the infrared light sensor. The infrared light sensing assembly 105 is protruding to expose the outside curvature of the Fresnel lens so that a relatively wide detection angle can be achieved. To ensure accurate detection of human presence, by properly adjusting the curvature of the Fresnel lens, the detection angle of the infrared light sensing assembly 105 is adjusted to be equal to or greater than an intended viewing angle of the TV so that if there is any human who is actually watching the TV, her or his presence will be detected.

Referring back to FIG. 1, the power control circuit 107 includes a signal amplifier 117, a comparator circuit 127 and a power switch 137, all of which are electrically connected to the power supply 103 and powered thereby. The comparator circuit 127 is electrically connected with the signal amplifier 117 and the power switch 137. The power switch 137 is electrically connected to the backlight module 101. When the infrared light sensing assembly 105 detects human presence in front of the TV within the detection angle, the infrared light sensing assembly 105 transmits a first voltage signal to the signal amplifier 117. The signal amplifier 117 is configured to amplify the first voltage signal and output an amplified signal with greater strength to the comparator circuit 127. The comparator circuit 127 is configured to compare the amplified signal received from the signal amplifier 117 with a predetermined signal and generate a first digital signal according to the result of the comparison. In this embodiment, the first digital signal is “1”. The power switch, upon receiving the first digital signal, is configured to connect the power supply and the backlight module so that electric power is transmitted from the power supply 103 to the backlight module 101 and the user 109 can watch the TV normally. Now, if the user 109 leaves the TV and the infrared light sensing assembly 105 does not detect any human presence in front of the TV within the detection angle, the infrared light sensing assembly 105 is configured to transmit a second voltage signal to the signal amplifier 117. The signal amplifier 117 is configured to amplify the second voltage signal and output an amplified signal with greater strength to the comparator circuit 127. The comparator circuit 127 is configured to compare the amplified signal received from the signal amplifier 117 with the above-mentioned predetermined signal and generate a second digital signal according to the result of the comparison. In this embodiment, the second digital signal is “0”. The power switch, upon receiving the second digital signal, is configured to disconnect the power supply and the backlight module so that the power supply 103 stops supplying electric power to the backlight module 101 and the backlight light is turned off. Thus electrical power consumed by the backlight module 101 is automatically saved.

It is noted when the infrared light sensing assembly 105 does not detect any human presence in front of the TV within the detection angle and the backlight is turned off, other functions of the TV such as audio playing is still working. The TV is still tuned in the same channel and having the same settings such as the volume level, the picture parameters, and etc. just as before. This is because although the power supply 103 stops supplying power to the backlight module 101, the power supply 103 is still supplying power to all the other components of the TV. If the user 109 now comes back to watch the TV and is sensed by the infrared light sensing assembly 105, the backlight module 101 will be connected to the power supply 103 again and the backlight will be turned back on. The transition of different statuses of the backlight module 101 is essentially instant. In this whole process, the user 109 does not need to do any manual adjustment to the TV to be able to have the backlight turned off when he is away to save electric power and to have the backlight turned back on when he comes back and enjoy watching the TV with exactly the same settings as they were before his leave.

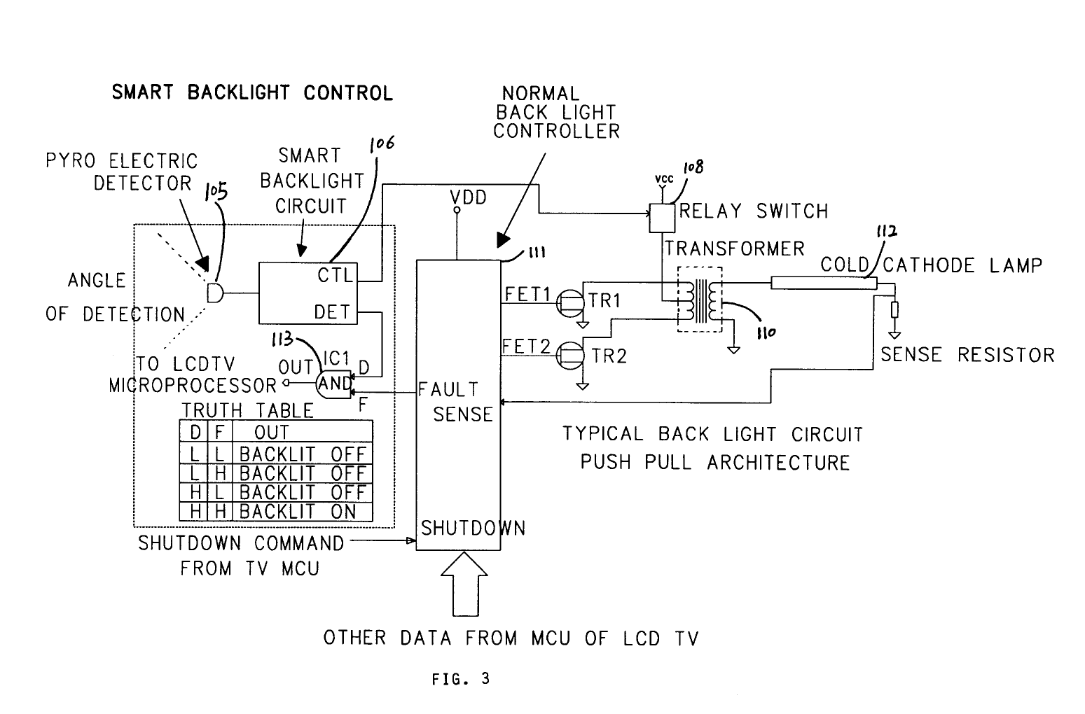

FIG. 3 is a schematic circuit diagram of a circuit that implements the system of this embodiment. Referring to FIG. 3, when the infrared light sensing assembly 105 detects human presence in front of the TV within the detection angle, the infrared light sensing assembly 105 transmits a first voltage signal to a smart backlight circuit 106. The smart backlight circuit 106 corresponds to and integrates the functions of the signal amplifier 117 and the comparator circuit 127 in FIG. 1. After amplifying the first voltage signal and comparing the amplified signal to a predetermined signal, the output ports “CTL” and “DET” of the smart backlight circuit 106 respectively output a digital signal, for example “1”, that represents a logic high. The “CTL” port is connected to a replay switch 108, which is controllable by a digital signal and controls electric current flowing into a transformer 110. The transformer 110 connects a backlight controller 111 and at least a cold cathode fluorescent lamp (CCFL) 112. The backlight controller is connected with the power supply of the TV (not shown in FIG. 3). The CCFL 112 is an essential lighting element of the backlight module in this embodiment and configured for emitting light when powered on. In this embodiment, there are multiple CCFLs. Because the “CTL” port of the smart backlight circuit 106 now outputs “1”, the replay switch 108 is turned on allowing current to flow into the transformer 110, which in turn allows electric power to be transmitted from the power supply to the CCFLs 112 through the backlight controller 111 and the transformer 110. Thereby when human presence is detected in front of the TV within the detection angle, the backlight module is powered on.

When the infrared light sensing assembly 105 does not detect any human presence in front of the TV within the detection angle, the infrared light sensing assembly 105 transmits a second voltage signal to the smart backlight circuit 106. After amplifying the second voltage signal and comparing the amplified signal to the predetermined signal, the output ports “CTL” and “DET” of the smart backlight circuit respectively output a digital signal, for example “0”, that represents a logic low. Because the “CTL” port of the smart backlight circuit 106 now outputs “0”, the replay switch 108 is turned off blocking current from flowing into the transformer 110, which in turn disallows electric power to be transmitted from the power supply to the CCFLs 112 through the backlight controller 111 and the transformer 110. Thereby when human presence is not detected in front of the TV within the detection angle, the backlight module is powered off.

Referring to FIG. 3, when electric power is supplied to the CCFLs 112, the current flowing through the CCFL is monitored at the “SENSE” port of the backlight controller 111. When this current is at a normal state, a digital signal “1” representing a logic high is output from the “FAULT” port of the backlight controller 111. When this current is not normal, a digital signal “0” representing a logic low is output from the “FAULT” port of the backlight controller 111. The circuit in FIG. 3 further includes an AND gate 113 having two input ports respectively connected to the “DET” port of the smart backlight circuit 106 and the “FAULT” port of the backlight controller 111, and an output port connected to a LCD microprocessor. The LCD microprocessor is configured to turn off the backlight controller 111 when the output of the AND gate 113 is “0” and turn on the backlight controller 111 when the output of the AND gate 113 is “1”. When the backlight controller 111 is turned off, no electric current or electric power is provided to the transformer 110 or the CCFL 112 through the backlight controller 111.

To better illustrate the operation of the system, suppose first that the user 109 is present in front of the TV within the detection angle and detected by the infrared light sensing assembly 105 so that the “DET” port of the smart backlight circuit 106 outputs “1”. If the current flowing through the CCFL 112 is normal, the “FAULT” port of the backlight controller 111 outputs “1”. As a result, the output port of the AND gate 113 is “1” and thereby the backlight controller 111 stays on. Now consider two scenarios:
(1) The user 109 leaves the region that can be sensed by the infrared light sensing assembly 105. In this case, the “DET” port of the smart backlight circuit 106 outputs “0”. As mentioned above, this will turn off the replay switch 108 and thereby the transformer 110 will not be transmitting electric power to the CCFLs 112. In addition, the current flowing through the CCFL 112 drops and becomes abnormal now because the transformer 110 stops working so that the “FAULT” port of the backlight controller 111 outputs “0” and thus the output of the AND gate 113 is “0”. As a result, the LCD microprocessor will turn off the backlight controller 111 so that the power supply will be disconnected to the transformer 110. Because the connection path between the power supply and the CCFLs 112 is broken at the backlight controller 111 and the transformer 110, the CCFLs 112 of the backlight module are turned off;
(2) The user 109 can still be detected by the infrared light sensing assembly 105 but the CCFLs 112 stop working properly for reasons such as that one of the lamps is broken for reaching its lifetime. In this case, the current flowing through the CCFLs 112 is not normal, for example, dropping significantly, so that the “FAULT” port of the backlight controller 111 outputs “0” and thus the output of the AND gate 113 is “0”. As a result, the LCD microprocessor will turn off the backlight controller 111 so that the power supply will be disconnected to the transformer 110. Thus, when one of the CCFLs 112 is not working properly, all the other CCFLs 112 are turned off as well.

In this embodiment, the backlight module 101 in FIG. 1 is a CCFL backlight module that includes multiple CCFLs. It is understood that the backlight module 101 can be of other types, such as a LED (light-emitting diode) backlight module, which includes multiple LEDs for providing the backlight. In that case, all the above-mentioned mechanisms and analyses still apply except that for a LED backlight module, the transformer 110 in FIG. 3 is driving multiple LEDs as backlights, instead of multiple CCFLs.

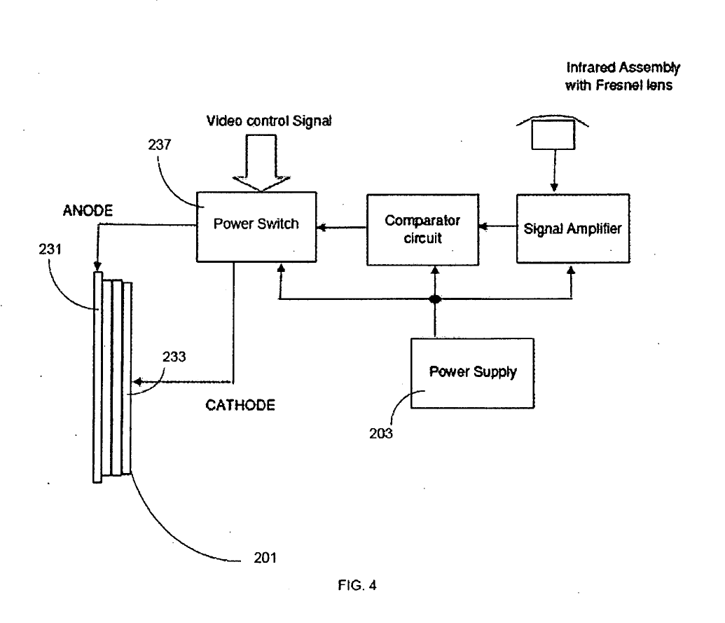

FIG. 4 is a functional block diagram of a system for controlling the light emission of a television according to another embodiment of the present patent application.

In this embodiment, the television has an OLED (organic light-emitting diode) display. Referring to FIG. 4, the OLED display does not have a backlight module. Instead, the brightness of the OLED display is controlled by the electric current flowing through the light emissive organic compound in an OLED assembly 201 of the display, which is further controlled by a driving voltage applied between an anode 231 and a cathode 233 of the OLED assembly 201. Hence the system for controlling the light emission of the OLED television in this embodiment is essentially the same as the system for controlling the light emission of the LCD television as mentioned above, except that in this embodiment, the power switch 237 is configured to connecting or disconnecting the power supply 203 and the OLED assembly 201 according to the digital signal that controls the power switch 237. It is understood that in a circuit implementation of the system in this embodiment, the driving ports of the CCFLs 112 in FIG. 3 should be respectively connected to the anode 231 and the cathode 233 instead so that the electric power supplied to the OLED assembly 201, which determines the light emission of the OLED TV, can be controlled by the system.

While the present patent application has been shown and described with particular references to a number of embodiments thereof, it should be noted that various other changes or modifications may be made without departing from the scope of the present invention.

What is the claimed is:

1. A system for controlling the light emission of a television, which has a backlight module and a power supply, the system comprising:
an infrared light sensing assembly for detecting human presence in front of the television within a predetermined detection angle; and
a power control circuit electrically connected to the infrared light sensing assembly, the power supply of the television, and the backlight module of the television; wherein:
the infrared light sensing assembly is configured to transmit a first signal to the power control circuit when human presence is detected, and transmit a second signal to the power control circuit when no human presence is detected, and the power control circuit is configured to allow electric power to be transmitted from the power supply to the backlight module when the first signal is received and disallow electric power to be transmitted from the power supply to the backlight module when the second signal is received.

2. The system of claim 1, wherein the power control circuit comprises a signal amplifier for amplifying the signal received from the infrared light sensing assembly, a comparator circuit for comparing the amplified signal with a predetermined signal and generating a digital signal according to the result of the comparison, and a power switch for receiving the digital signal generated by the comparator circuit and connecting or disconnecting the power supply and the backlight module of the television according to the digital signal.

3. The system of claim 1, wherein the infrared light sensing assembly comprises an infrared light sensor, a Fresnel lens encapsulating the infrared light sensor and a long pass filter that is deposited on the Fresnel lens and disposed between the infrared light sensor and the Fresnel lens.

4. The system of claim 3, wherein the long pass filter attenuates shorter wavelengths and passes longer wavelengths over the spectrum of 5 μm to 7 μm.

5. The system of claim 3, wherein the infrared light sensing assembly is protruding to expose the outside curvature of the Fresnel lens and the predetermined detection angle of the infrared light sensing assembly is equal to or greater than an intended viewing angle of the television.

6. The system of claim 1, wherein when the power control circuit disallows electric power to be transmitted from the power supply to the backlight module upon receiving the first signal, the power supply continues to supply electric power to all the components of the television other than the backlight module.

7. The system of claim 2, wherein the power switch comprises a relay switch connected to the comparator circuit and a transformer, the transformer being controlled by the relay switch and configured for establishing a connection between the power supply and the backlight module for power transmission, and the relay switch being configured for allowing or disallowing the connection according to the digital signal generated by the comparator circuit.

8. The system of claim 2, wherein the power switch comprises a microprocessor, the microprocessor being connected to the comparator circuit and configured for allowing and disallowing a connection between the power supply and the backlight module for power transmission according to the digital signal generated by the comparator circuit.

9. The system of claim 8, wherein the power switch further comprises an AND gate for performing a logical AND operation of the digital signal generated by the comparator circuit and a digital signal representing whether the backlight module is working properly, the result of the logical AND operation being output to the microprocessor.

10. The system of claim 1, wherein the backlight module comprises at least a cold cathode fluorescent lamp.

11. The system of claim 1, wherein the backlight module comprises a plurality of light-emitting diodes.

12. A system for controlling the light emission of a television, which has an organic light-emitting diode (OLED) assembly and a power supply, the system comprising:
an infrared light sensing assembly for detecting human presence in front of the television within a predetermined detection angle; and
a power control circuit electrically connected to the infrared light sensing assembly, the power supply of the television, and the OLED assembly of the television; wherein:
the infrared light sensing assembly is configured to transmit a first signal to the power control circuit when human presence is detected, and transmit a second signal to the power control circuit when no human presence is detected, and the power control circuit is configured to allow electric power to be transmitted from the power supply to the OLED assembly when the first signal is received and disallow electric power to be transmitted from the power supply to the OLED assembly when the second signal is received.

13. The system of claim 12, wherein the power control circuit comprises a signal amplifier for amplifying the signal received from the infrared light sensing assembly, a comparator circuit for comparing the amplified signal with a predetermined signal and generating a digital signal according to the result of the comparison, and a power switch for receiving the digital signal generated by the comparator circuit and connecting or disconnecting the power supply and the OLED assembly of the television according to the digital signal.

14. The system of claim 12, wherein the infrared light sensing assembly comprises an infrared light sensor, a Fresnel lens encapsulating the infrared light sensor and a long pass filter that is deposited on the Fresnel lens and disposed between the infrared light sensor and the Fresnel lens.

15. The system of claim 14, wherein the long pass filter attenuates shorter wavelengths and passes longer wavelengths over the spectrum of 5 μm to 7 μm.

16. The system of claim 14, wherein the infrared light sensing assembly is protruding to expose the outside curvature of the Fresnel lens and the predetermined detection angle of the infrared light sensing assembly is equal to or greater than an intended viewing angle of the television.

17. The system of claim 12, wherein when the power control circuit disallows electric power to be transmitted from the power supply to the OLED assembly upon receiving the first signal, the power supply continues to supply electric power to all the components of the television other than the OLED assembly.

18. The system of claim 13, wherein the power switch comprises a relay switch connected to the comparator circuit and a transformer, the transformer being controlled by the relay switch and configured for establishing a connection between the power supply and the OLED assembly for power transmission, and the relay switch being configured for allowing or disallowing the connection according to the digital signal generated by the comparator circuit.

19. The system of claim 13, wherein the power switch comprises a microprocessor, the microprocessor being connected to the comparator circuit and configured for allowing and disallowing a connection between the power supply and the OLED assembly for power transmission according to the digital signal generated by the comparator circuit.

20. The system of claim 19, wherein the power switch further comprises an AND gate for performing a logical AND operation of the digital signal generated by the comparator circuit and a digital signal representing whether the OLED assembly is working properly, the result of the logical AND operation being output to the microprocessor.
